(19) United States
(12) Patent Application Publication
(10) Pub. No.: US 2008/0296869 A1
(43) Pub. Date: Dec. 4, 2008

(54) MECHANICAL LIFT

(76) Inventor: Vitor Hugo Duarte Santos, Caxias do Sul (BR)

Correspondence Address: SUGHRUE MION, PLLC, 2100 PENNSYLVANIA AVENUE, N.W., SUITE 800, WASHINGTON, DC, 20037, US

(21) Appl. No.: 12/062,081

(22) Filed: Apr. 3, 2008

(30) Foreign Application Priority Data
Jun. 4, 2007 (BR) PI 0701201-2

(51) Int. Cl. B60D 1/66

(52) U.S. Cl. 280/475

(57) ABSTRACT

“Mechanical Lift”, as described in the report and according to the figures in annex, is distinctive for being a mechanical device intended for lifting and steadying trailers and semi-trailers, loaded or unloaded, aiming at providing a higher loading capacity and easier operation by the driver through the simplicity of its operation, together with enhancing the durability of the tractor and trailer set and enabling easier maintenance.

### CROSS REFERENCE TO RELATED APPLICATIONS

This application claims priority from Brazilian Patent Application No. PI 0701201-2, filed on Jun. 4, 2007, the disclosure of which is incorporated herein by reference.

### BACKGROUND OF THE INVENTION

1. Field of the Invention

The present Invention Patent refers to a mechanical device used for lifting and supporting trailers and semi-trailers, loaded or unloaded, aiming at providing a higher loading capacity (up to 16 ton) and easier operation by the driver through the simplicity of its operation, together with enhancing the durability of the tractor and trailer set and enabling easier maintenance.

2. Description of the Related Art

The State-of-the-Art Technique, which is the reason of the present improved construction, has been known through patent applications of Utility Models by this same applicant, which are being processed under Application Numbers MU 8201270-9, MU 8203002-2, MU 8402864-5 and MU 8700306-6. Notwithstanding, all the previous subjects are built using combined hydraulic-pneumatic or hydraulic-mechanic mechanisms.

### SUMMARY OF THE INVENTION

The present Mechanic Lift retains the main same external building features of the models referred above and of other models currently available in the market, however presenting a new internal construction, which contains a purely mechanical mechanism, which consists of a “crown wheel and worm-screw gearing system”, therefore achieving an outstanding innovation in the fabrication of the object regarding the State-of-the-Art Technique, and resulting in improved practices and functionality in the application of lifting devices for road trailers and semi-trailers.

For achieving such purpose, the current object introduces a simplified and unprecedented building technique in the application it is aimed at, mainly regarding the operation time and maintenance easiness of the elements of the assemblage, thus as a consequence reducing the operational costs and fabrication.

The development has resulted in a device that is manually operated through a handle, but which consists internally of a mechanical set that is both simplified and highly efficient.

The application of the current Mechanical Lift is for its utilization in supporting and steadying trailers or semi-trailers during the procedures of coupling and uncoupling to the truck tractor. When used as a vehicle utility, the Mechanical Lift is used for heavy-haul transportation in many different types of vehicles, such as auto-transport semi-trailers trucks, bulk cargo trucks, box trucks, and all kinds of trailers or semi-trailers.

The current proposal of the new Mechanical Lift offers the following advantages:

By using a high-resistance mechanical system, the load lifting capacity (load inside the trailer or semi-trailer) is higher, reaching a lifting capacity of up to 16 ton.

The static load, meaning the weight to be supported when the trailer or semi-trailer is parked, is also higher, reaching up to 32 ton of static load.

Due to the fact that the mechanical system comprises gears and worm screws for the transmission and amplification of the movement, less effort is required from the operator for lifting and lowering movements, besides providing greater agility to the process.

The lifting operation is performed with the trailer or semi-trailer either loaded or unloaded.

Greatest operating facility due to less effort needed for lifting the nominal weight capacity of 16 ton.

Greater functionality and maneuverability of the Mechanical Lift, which has been designed aiming at easy maintenance and at introducing lower cost equipment to the customer.

### BRIEF DESCRIPTION OF THE DRAWINGS

For the purpose of making the research easier and to provide full understanding of the present patent, as set forth in the report, according to a basic and preferential template established by the applicant, reference is made to the illustrations enclosed, which form an integral part and support the present descriptive report, whereas:

FIG. 01—Representation in perspective of the Mechanical Lift, showing both right and left sides

FIG. 02—Front view of the assemblage

FIG. 03—Left side view of the assemblage

FIG. 04—Upper view of the assemblage

FIG. 05—View in perspective of the Mechanical Lift, showing in detail the left foot gear box

FIG. 06—View in perspective of the Mechanical Lift, showing internal detail of the telescopic right foot plate.

FIG. 07—View in perspective of the Mechanical Lift, showing internal detail of the telescopic left foot plate.

FIG. 08—AA section, showing internal details of the telescopic left foot plate.

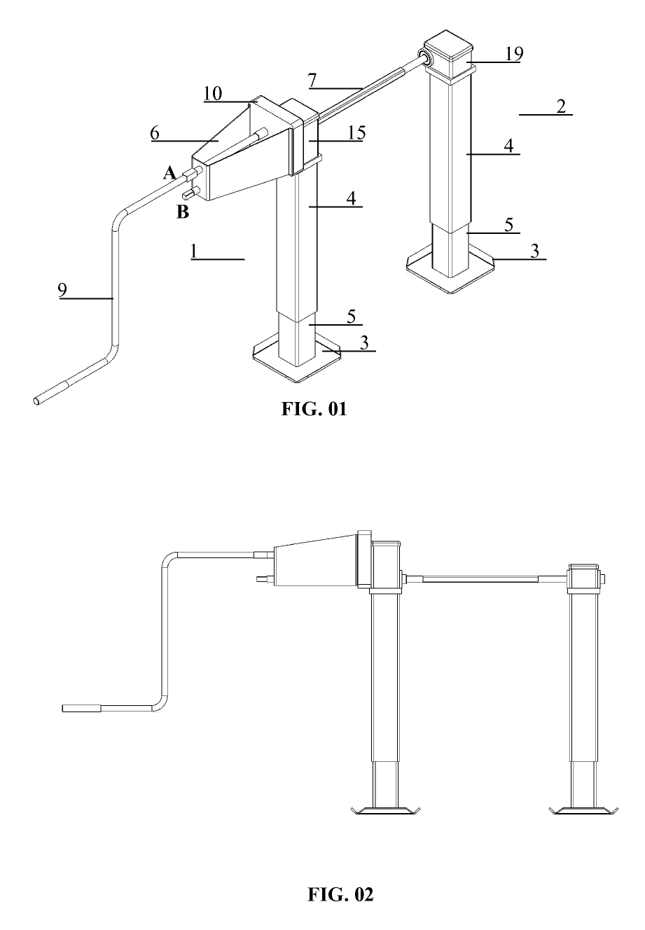

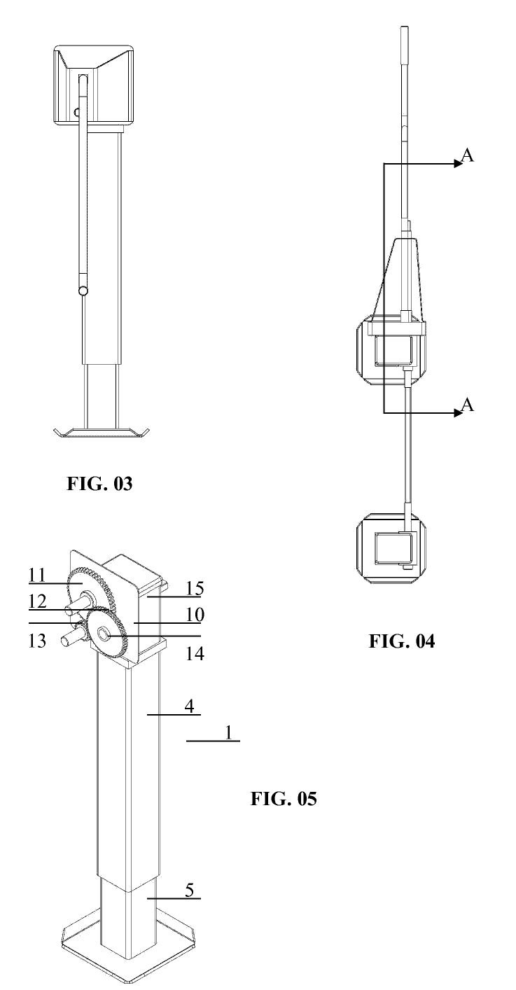

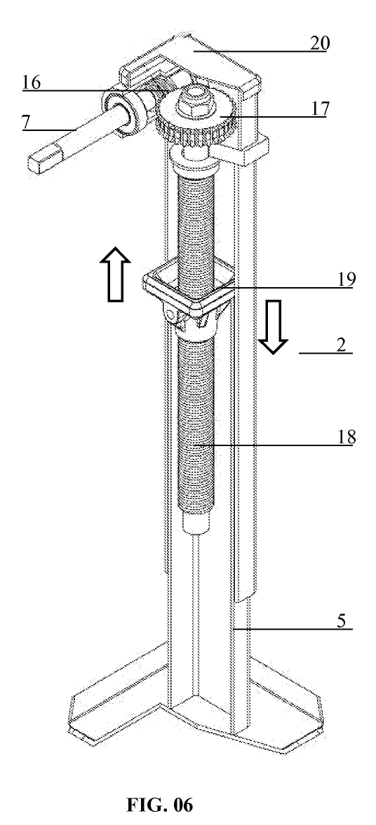

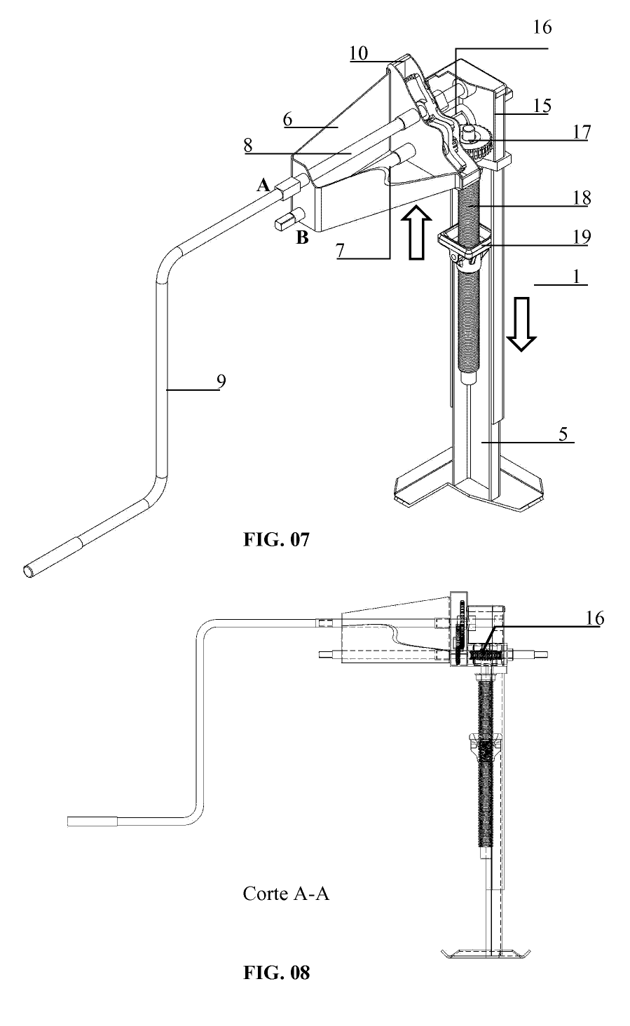

### DETAILED DESCRIPTION OF THE EXEMPLARY EMBODIMENT

As shown in the figures referred above, the object of the present patent comprises the left 1 and right 2 telescopic foot plates which contain regular base 3. The left 1 and right 2 telescopic foot plates are provided by upper part 4 and lower part 5, and they enable a stroke stage through the telescopic movement of the lower part 5.

Attached to the left telescopic foot plate 1 is the stabilization external support 6 that has a trapezoid shape, and contains bars 8 and 7 where the handle 9 can be inserted to, depending on the operation to be performed.

To the stabilization external support 6 the gear box 10 is coupled. The gear box contains the gearings 11, 12 and 13 that are responsible for the extension and the reduction of the movement. The gearing 11 has the largest diameter, the gearing 12 has the intermediary diameter, and the gearing 13 has the smallest diameter. All the gearings are fixed through washer 14.

The control box 15 fixed to the upper portion of the left telescopic foot plate 1 contains the extension of the bars 7 and 8. The bar 7 has in its end the worm screw 16 and the crown 17. Inside the telescopic foot plate 1, the crown 17 is fixed to the threaded bar 18 that contains the thread of the nut 19, which is responsible for the advancement and recoil of the lower part 5 of the foot plate.

The bar 7 is an extension until the right telescopic foot plate 2 in order to transmit the movement generated by the moving of the handle 9 in a way as to allow that the advancement or recoil movement of the lower part of the left 1 and right 2 foot plates happens at the same time.

In the same fashion, the right telescopic foot plate 2 has on its upper part, the control box 20 that contains the extension of the bar 7, to the end of which the worm screw 16 and the crown 17 are attached. Internally to the telescopic foot plate 2 the crown 17 is attached to the threaded bar 18, which contains the nut thread 19, which is responsible for the advancement or recoil movement of the lower part of the foot plate 5.

The handle 9 may be replaced by any other mechanical device, by other pneumatic mechanism, such as the continuous pneumatic pump, by other hydraulic or pneumatic mechanism, or by other mechanisms operated by compressed air.

The present patent is set in motion as follows:

For the Advancement of the Telescopic Foot Plate:

Set the handle in position A and start the movement in the clockwise direction. The movement is received initially by the gearing 11 and is transmitted to gearings 12 and 13 in order to amplify its result. This means that the number of turns of the handle 9 is multiplied through the transmission between gearings.

The smallest diameter gearing 13 that is connected to bar 7 transmits the movement to the crown 17 through the worm screw 16. The movement caused to the crown 17 is transmitted to the threaded bar 18 making the nut thread 19 to provide for the advancement movement of the lower part of telescopic foot plate 5 until it touches the ground.

For lifting the trailer or semi-trailer up the position that enables the uncoupling of the tractor truck, handle 9 is set in position B and turned clockwise. The movement is received by gearing 13 and is transmitted directly to the crown 17 through the worm screw 16, giving continuation to the advancement movement of the lower part 5 of the telescopic foot plate until this reaches the desired final position.

For the Recoil of the Telescopic Foot Plate:

Set the handle 9 in position B and initiate its movement counter-clockwise. The movement is received directly by the gearing 13 that is attached to bar 7, and transmits the movement to crown 17 through the worm screw 16. The movement caused to crown 17 is transmitted to thread bar 18 and makes the nut thread 19 to provoke the recoil movement in the lower part 5 of the telescopic foot plate until the trailer or semi-trailer is coupled onto the tractor truck.

To accelerate the recoil of the lower part 5 of the telescopic foot plate until the end of the stroke, after the coupling of the trailer or semi-trailer to the tractor truck, the handle 9 is set in position A and turned clockwise, making the recoil movement through gearing 13 to be made with higher speed.

Since the left 1 and right 2 telescopic foot plates are connected through bar 7, all movement generated by the handle is transmitted to both foot plates simultaneously, so that the movement is equal is both foot plates, for either the advancement or the recoil.

As a consequence, the Mechanical Lift is substantiated by unprecedented technical and functional features, as can be observed in the annexed figures, and understood from the description report, hence deserving the legal protection herewith requested.

1. A mechanical lift, comprising:
first and second telescopic foot plates, each of the foot plates including
an upper part and a lower part,
a threaded bar with a crown that is engaged with a worm screw, and
a nut thread connected to the lower part and engaged with threads of the threaded bar, wherein rotation of the threaded bar provides movement between the upper part and the lower part; and
a gear box connected to the upper part of the first foot plate, wherein the gear box includes a larger diameter gear and a smaller diameter gear, wherein the smaller diameter gear is connected to the worm screw of the first foot plate, and the larger diameter gear transmits a rotation to the smaller diameter gear;
wherein the larger diameter gear is connected to a first bar that includes an input portion adapted to be coupled to a rotation input device, and the smaller diameter gear is fixed to a second bar that includes an input portion adapted to be coupled to the rotation input device and that is connected to the worm screw of the first foot plate.

2. The mechanical lift of claim 1, wherein the rotation input device is a handle.

3. The mechanical lift of claim 1, wherein the rotation input device is a mechanical, hydraulic, or pneumatic device.

4. The mechanical lift of claim 1, wherein the rotation input device is a mechanism operated by compressed air.

5. The mechanical lift of claim 1, wherein the gear box further comprises an intermediate gear that transmits rotation of the larger diameter gear to the smaller diameter gear.

6. The mechanical lift of claim 5, wherein the intermediate gear has a diameter that is smaller than the larger diameter gear and larger than the smaller diameter gear.

7. The mechanical lift of claim 6, further comprising an external stabilization support attached to the first foot plate, wherein a portion of the first bar and a portion of the second bar are provided within the external stabilization support.

8. The mechanical lift of claim 7, wherein the external stabilization support has a trapezoid shape.

9. The mechanical lift of claim 8, wherein each of the smallest gear, the intermediate gear, and the largest gear is fixed to the gear box by a respective washer.

10. The mechanical lift of claim 9, wherein the rotation input device is a handle.

11. The mechanical lift of claim 9, wherein the rotation input device is a mechanical, hydraulic, or pneumatic device.

12. The mechanical lift of claim 9, wherein the rotation input device is a mechanism operated by compressed air.
